(19) United States
(12) Patent Application Publication
(10) Pub. No.: US 2015/0003358 A1
(43) Pub. Date: Jan. 1, 2015

(54) WIRELESS COMMUNICATION SYSTEM AND A METHOD OF CONTROLLING THE SAME

(71) Applicant: Agency for Science, Technology and Research, Singapore (SG)

(72) Inventors: Haiguang Wang, Singapore (SG); Shoukang Zheng, Singapore (SG); Jaya Shankar s/o Pathmasuntharam, Singapore (SG); Anh Tuan Hoang, Singapore (SG); Wai Leong Yeow, Singapore (SG); Chee Ming Joseph Teo, Singapore (SG); Zhongding Lei, Singapore (SG)

(73) Assignee: AGENCY FOR SCIENCE, TECHNOLOGY AND RESEARCH, Singapore (SG)

(21) Appl. No.: 14/372,313

(22) PCT Filed: Jan. 16, 2013
(86) PCT No.: PCT/SG2013/000020

§ 371 Date: Jul. 15, 2014

(30) Foreign Application Priority Data
Jan. 16, 2012 (SG) SG201200345-5
Mar. 12, 2012 (SG) SG201201750-5

(51) Int. Cl. H04W 72/04

(52) U.S. Cl. CPC H04W 72/0413
USPC 370/329

(57) ABSTRACT

In various embodiments, a method of selecting one or more nodes from a plurality of nodes for establishing wireless communication with an access point including defining a filter, filtering the one or more nodes from the plurality of nodes using the filter and sending a linking signal from each of the one or more nodes to the access point for establishing wireless communication with the access point.

### CROSS-REFERENCE TO RELATED APPLICATIONS

This application claims the benefit of priority of SG application No. 201200345-5 filed Jan. 16, 2012, as well as SG application No. 201201750-5, filed on Mar. 12, 2012, the contents of them being hereby incorporated by reference in its entirety for all purposes.

### TECHNICAL FIELD

Various aspects of this disclosure relate to wireless communication systems and methods for controlling the same.

### BACKGROUND

The IEEE 802.11 standards define a family of protocols for implementing Wireless Local Area Networks (WLAN). The communication range is up to a few hundred meters and usually is about two to three hundred meters. The standards is created and maintained by IEEE LAN/MAN Standard Committee (IEEE 802). The standards are used in various scenarios such as networks for home/offices, factories, and cellular communications.

The IEEE 802.11 standard is designed as communication protocols for Wireless Local Area Networks (WLAN). Usually, an access point (AP) works with a few to a few tens of stations associated to it and within a range of a few hundred meters. The current standard can easily handle such a small scale of networks.

However, with new application scenarios for WLAN, such as Smart Grids for power networks, an AP may required to extend its coverage to 1 km, and handle a few thousands of nodes (up to 6000 as required by the 801.11ah standard amendment requirements) with low transmission speed.

Smart Grids for power networks are expected to play a critical role in energy management and distribution. Smart Grids help to improve power utilization and reduce the energy consumed by the power networks.

The IEEE 802.11 standard is one of the candidate communication technologies for data aggregation in Smart Grids applications. However, to support Smart Grids applications, amendments to the current IEEE 802.11 standard are required. Based on the report provided by the 802.11ah task group, which is established for supporting radio band below 1 GHz, the IEEE 802.11 standards should be amended in at least two aspects relating to coverage and the number of nodes or stations supported by a single Access Point (AP). The coverage should be extended from a few hundred meters to 1 km and the maximum number of nodes or stations supported by a single AP should be increased up to 6000. In the current IEEE 802.11 standards, the AP cannot handle a large number of nodes or stations performing authentication/association to it simultaneously.

With such application scenarios, it is possible that a few thousands of nodes or stations want to transmit to an AP at the same time. It has been demonstrated that the current standard cannot handle such a large amount of nodes or stations trying to access the network simultaneously, including Authentication and Association procedures, which are pre-request procedures for a node or a station to access the network via a given AP.

### SUMMARY

Various aspects of this disclosure provide a method and system that is able to address at least partially the abovementioned challenges.

In various embodiments, a method for controlling a node may be provided. The method may include receiving information on a filter from an access point, determining whether to send a linking signal to the access point based on the filter and sending the linking signal to the access point for establishing wireless communication with the access point if the node is determined to send the linking signal.

In various embodiments, a node may be provided. The node may include a receiver configured to receive information on a filter from an access point, a determination circuit configured to determine whether to send a linking signal to the access point based on the filter and a transmitter configured to send the linking signal to the access point for establishing wireless communication with the access point if the node is determined to send the linking signal.

In various embodiments, a method for controlling an access point may be provided. The method may include generating a filter, the filter indicating whether to select one or more nodes from the plurality of nodes for establishing wireless communication with the access point, and sending information on the filter to each of the plurality of nodes.

In various embodiments, an access point may be provided. The access point may include a generating circuit configured to generate a filter, the filter indicating whether to select one or more nodes from the plurality of nodes for establishing wireless communication with the access point, and a transmitter configured to send information on the filter to each of the plurality of nodes.

In various embodiments, a method for controlling a wireless communication system may be provided. The method may include generating a filter, filtering one or more nodes from a plurality of nodes using the filter and sending a linking signal from each of the one or more nodes to the access point for establishing wireless communication with an access point.

In various embodiments, a wireless communication system may be provided. The wireless communication system may include an access point and a plurality of nodes, wherein the system is configured such that one or more nodes is filtered from the plurality of nodes and each of the one or more nodes is configured to send a linking signal to the access point for establishing wireless communication with the access point.

### BRIEF DESCRIPTION OF THE DRAWINGS

The invention will be better understood with reference to the detailed description when considered in conjunction with the non-limiting examples and the accompanying drawings, in which:

FIG. 1 is a schematic illustrating the procedures for Authentication and Association.

FIG. 2 shows a network topology of a single access point and a plurality of nodes or stations randomly distributed around the access point.

FIG. 3A is a plot illustrating the number of nodes or stations completing the Authentication and Association procedures as a function of time when the total number of nodes or stations are varied. FIG. 3B is a plot illustrating the number of nodes or stations completing the Association procedures as a function of time when the total number of retransmissions is varied. The total number of nodes or stations, including the AP, is 300. FIG. 3C is a plot illustrating the number of nodes or stations completing the Association procedures as a function of time when the total number of retransmission is varied. The total number of nodes, including the AP, is 500. FIG. 3D is a plot illustrating the number of nodes or stations completing the Association procedures as a function of time when the total number of retransmission is varied. The total number of nodes, including the AP, is 1000. FIG. 3E is a plot illustrating the number of nodes or stations completing the Association procedures as a function of time when there is no retransmission. The total number of nodes, including the AP, is 2000.

FIG. 4 is a schematic illustrating a method according to various embodiments for controlling a wireless communication system including defining a filter, filtering one or more nodes from a plurality of nodes using the filter and sending a linking signal from each of the one or more nodes to the access point for establishing wireless communication with an access point.

FIG. 5 is a plot illustrating the number of nodes or stations completing the Authentication and Association procedures using MAC address filtering according to various embodiments as a function of time when the total number of nodes or stations are varied.

FIG. 6A is a plot illustrating shows the variation of the Qₘ (current queue length for management signaling), Wₘₐₓ (upper limit) and ΔW (change in upper limit) as a function of time for a communication system employing MAC address filtering according to various embodiments when the total number of nodes, including the AP, is fixed at 1000. FIG. 6B is a plot illustrating shows the variation of the Qₘ, Wₘₐₓ and ΔW as a function of time for a communication system employing MAC address filtering according to various embodiments when the total number of nodes, including the AP, is fixed at 3000.

FIG. 7A is a plot illustrating the number of nodes or stations completing the Authentication and Association procedures under IEEE 802.11-2007 as a function of time when the total number of nodes or stations are varied. FIG. 7B is a plot illustrating the number of nodes or stations completing the Authentication and Association procedures using random number filtering according to various embodiments as a function of time when the total number of nodes or stations is varied.

FIG. 8 is a schematic illustrating a wireless communication system according to various embodiments including an access point and a plurality of nodes, wherein the system is configured such that one or more nodes is filtered from the plurality of nodes and each of the one or more nodes is configured to send a linking signal to the access point for establishing wireless communication with the access point.

FIG. 9A is a schematic illustrating a node according to various embodiments for wireless communication with an access point. FIG. 9B is a schematic illustrating a method according to various embodiments for controlling a node including receiving information on a filter from an access point, determining whether to send a linking signal to the access point based on the filter, and sending the linking signal to the access point for establishing wireless communication with the access point if the node is determined to send the linking signal.

FIG. 10A is a schematic illustrating an access point according to various embodiments for wireless communication with a node. FIG. 10B is a schematic illustrating a method according to various embodiments for controlling an access point, the method including generating a filter, the filter configured to select one or more nodes from the plurality of nodes for establishing wireless communication with the access point.

FIG. 11 shows an illustration of an authentication control information element (IE).

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

In order that the invention may be readily understood and put into practical effect, particular embodiments will now be described by way of examples and not limitations, and with reference to the figures.

Under IEEE Standard 802.11 for Information Technology—Telecommunications and Information Exchange between Systems—Local and Metropolitan Area Networks—Specific Requirements Part 11: Wireless LAN Medium Access Control (MAC) and Physical Layer (PHY) Specifications, a station (STA) is defined as any device that contains an IEEE 802.11—conformant medium access control (MAC) and physical layer (PHY) interface to the wireless medium (WM).

According to various embodiments, a node may be a component or device or means capable for transmitting and receiving information via wireless means. According to various embodiments, a node may be a station as defined in IEEE Standard 802.11. Unless otherwise explicitly stated, references to nodes usually refer to non-access point (non-AP) nodes.

In various embodiments, a node or station may be a mobile device such as mobile phone or a laptop with a wireless interface controller. In various embodiments, the node or station may be a desktop computer with a wireless interface controller.

Under IEEE Standard 802.11 for Information Technology—Telecommunications and Information Exchange between Systems—Local and Metropolitan Area Networks—Specific Requirements Part 11: Wireless LAN Medium Access Control (MAC) and Physical Layer (PHY) Specifications, an access point is defined as any entity that has station (STA) functionality and provides access to distribution services, via the wireless medium (WM) for associated stations (STAs).

According to various embodiments, an access point may be a component or device or means that provides access between associated nodes to other communication systems, devices or components via wireless means between the associated nodes and the access point. According to various embodiments, an access point includes, but is not limited to an access point as defined under the IEEE Standard 802.11.

In various embodiments, an access point may be a device that allows wireless devices to connect to a wired network using Wi-Fi or related standards. In various embodiments, the access point may be connected to a router via a wired network or may be part of a router itself. The router may provide communication with external networks. In various embodiments, an AP may be a hotspot. In various embodiments, an AP may be incorporated in a battery-powered router or smartphone. The battery-powered router or smartphone may also include a cellular mobile Internet radio modem. When subscribed to a cellular phone carrier, the battery-powered router or smartphone allows nearby Wi-Fi stations to access the Internet through cellular networks such as 2G, 3G or 4G networks.

Under IEEE Standard 802.11 for Information Technology—Telecommunications and Information Exchange between Systems—Local and Metropolitan Area Networks—Specific Requirements Part 11: Wireless LAN Medium Access Control (MAC) and Physical Layer (PHY) Specifications, authentication refers to a service used to establish the identity of one station (STA) as a member of the set of STAs authorized to associate via another STA. According to various embodiments, authentication refers to a service used to establish of one node as a member of the set of non-AP nodes authorized to associate via an AP, and includes, but is not limited to authentication as defined under the IEEE Standard 802.11.

Under IEEE Standard 802.11 for Information Technology—Telecommunications and Information Exchange between Systems—Local and Metropolitan Area Networks—Specific Requirements Part 11: Wireless LAN Medium Access Control (MAC) and Physical Layer (PHY) Specifications, association refers to a service used to establish access point/station (AP/STA) and enable STA invocation of the distribution system services (DSSs). According to various embodiments, association refers to a service used to establish access between an AP and a non-AP node and includes, but is not limited to association as defined under the IEEE Standard 802.11.

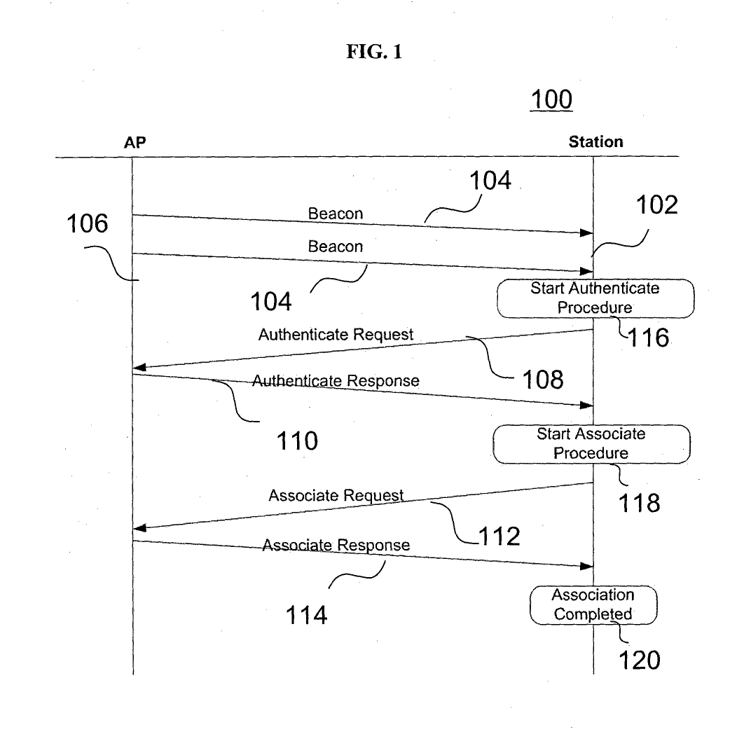

In IEEE 802.11 standard, before a node or a station can use an AP for network access, it must link with the AP using the Authentication/Association procedures first. FIG. 1 is a schematic illustrating the procedures 100 for Authentication and Association. The start Authenticate Procedure is shown in 116. When a node or a station 102 receives a beacon signal 104 from an AP 106 and decides to join the local area network (LAN) managed by the AP 106, it first sends an Authenticate Request 108 to the AP 106. The AP 106 sends back an Authenticate Response 110 after receiving the Authenticate Request 108. The Authenticate Response 110 indicates whether the node or station 102 is accepted for network access or not. If the Authenticate Response 110 indicates that the node or station 102 is allowed to access the network via the AP 106, then the node or station 102 further sends an Associate Request 112 to the AP 106 under the Start Associate Procedure in 118. On receiving the Associate Request 112, the AP 106 will transmit an Associate Response 114 to the node or station 102. After receiving the Associate Response 114 from the AP 106, the node or station 102 may then start to use the AP 106 to transmit/receive data to/from networks. The Association is completed in 120. Each Authentication procedure or transaction includes an Authentication Request 108 and an Authentication Response 110. Each Association procedure or transaction includes an Association Request 112 and an Association Response 114.

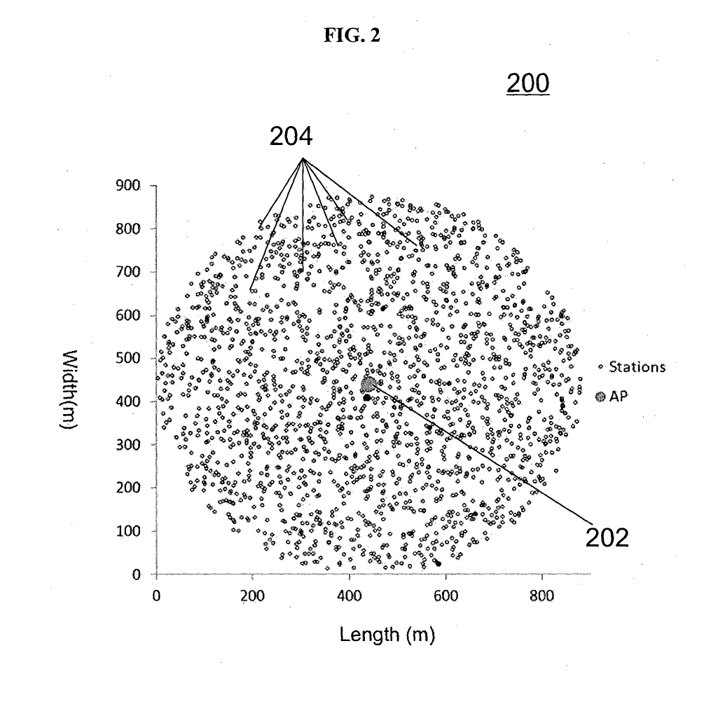

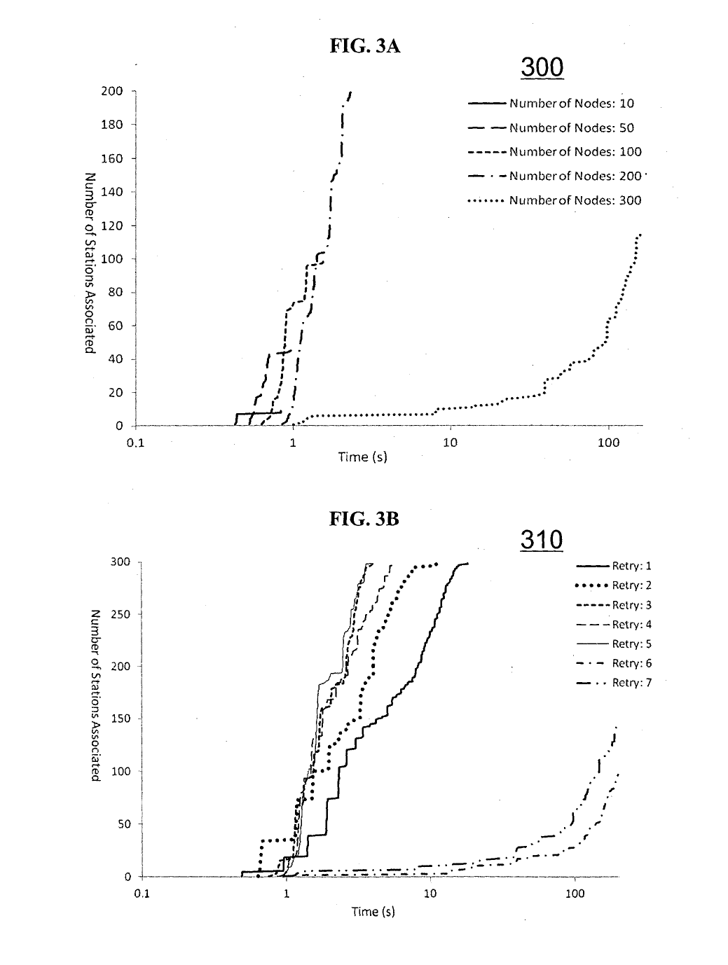

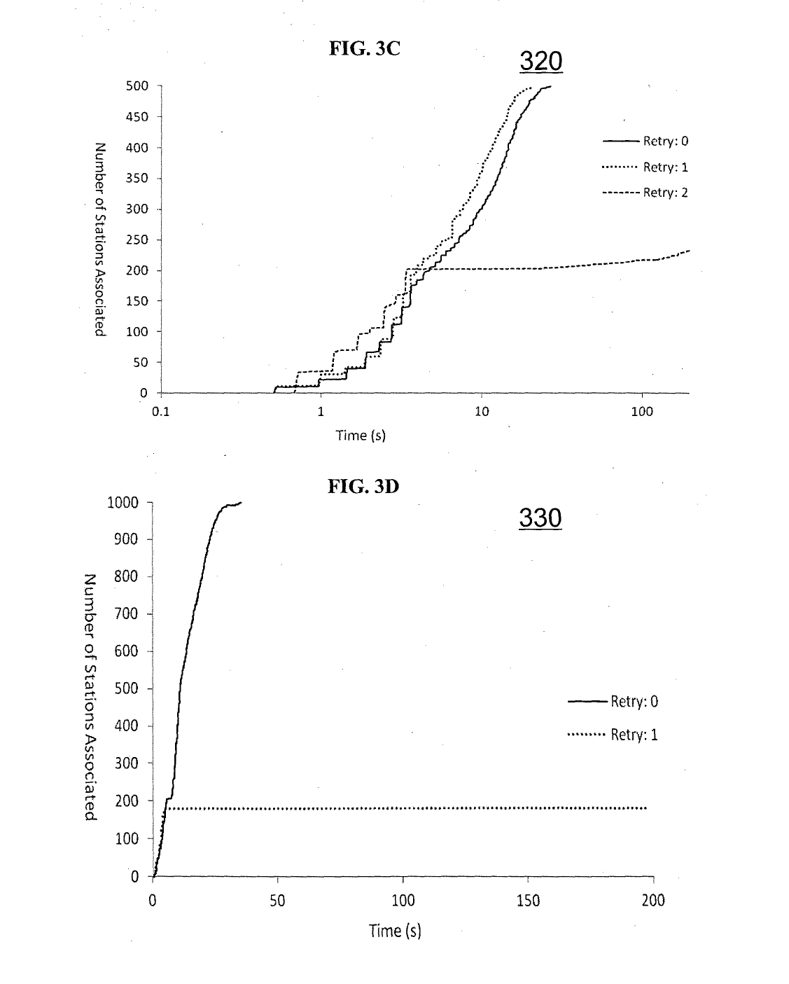

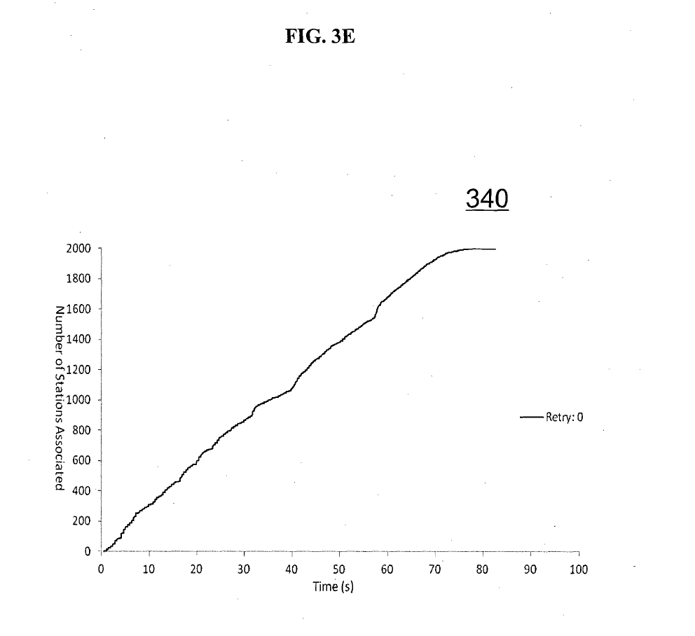

To test the capability of a single 802.11 AP in supporting large number of 802.11 nodes or stations, a simulation scenario may be set up with a single AP and a variable number of nodes or stations randomly distributed around the AP. FIG. 2 shows a network topology 200 of a single AP 202 and a plurality of nodes or stations 204 randomly distributed around the AP 202. The communication range between AP and stations is 450 meters. The number of nodes or stations 204 varies from 10 to 3000. The data rate is 1 Mbps. The propagation model used in the simulation is two-ray ground. The two-ray ground reflection model considers both the direct path and a ground reflection path between two nodes. The Request to Send/Clear to Send (RTS/CTS) threshold is set to 1500 bytes and it is not used during the simulation since control messages for authentication and association is small. A node may retry up to 7 times when the transmission of a uni-cast packet failed either due to channel corruption or collision. The run time for simulation is set to 200 seconds. The capabilities of IEEE 802.11 standards in supporting large numbers of nodes or stations with a general configuration are examined. FIGS. 3A-D show the time required for nodes or stations to complete the Authentication and Association procedures under various conditions. The number of nodes or stations in the simulation, including one Access Point (AP), varies from 10 to 300. FIG. 3A is a plot 300 illustrating the number of nodes or stations completing the Authentication and Association procedures as a function of time when the total number of nodes or stations are varied. When the number of nodes or stations are below 200, the network can handle the Authentication and Association procedures decently. For example, it only takes about 2.30 seconds to get all 199 nodes or stations to finish the Authentication and Association procedures. However, when the number of nodes or stations increases to 300, the delay increases significantly and only 147 nodes or stations manage to finish the Authentication and Association procedures within 200 seconds.

There are two reasons causing the delay. Firstly, the collision from hidden terminals cause transmission failure frequently and cause Authentication/Association Request/Response to be dropped. Stations or nodes may have to restart the Authentication/Association procedures after timeout. Secondly, since the AP and nodes or stations are treated equally when accessing channels, many Authentication/Association responses are accumulated at the packet queue of the AP to be transmitted. The delay in transmitting Authentication/Association responses also contribute to the Authentication/Association procedures timeout at the nodes or stations and results in restart of the Authentication/Association procedures.

According to various embodiments, devices and methods may be provided which reduce collisions. The number of retransmissions may be kept low at the station or node side so that the Authentication/Association responses at AP side get higher chances in being transmitted to stations successfully. The number of retransmissions is the number of times a node will automatically try to establish communication with the access point after failing to do so the first time. When a node has reached a predefined number of retransmissions, it will stop trying to establish communication with the access point. FIG. 3B is a plot 310 illustrating the number of nodes or stations completing the Association procedures successfully as a function of time when the total number of retransmissions is varied. The total number of nodes or stations, including the AP, is 300. With 300 nodes, reducing the number of retransmissions at the station or node side can improve the performance significantly. FIG. 3B shows that as long as the number of retransmissions are kept below 6, the nodes or stations can finish the Association procedures within 20 seconds. However, this does not mean that better performance comes with lesser number of retransmissions. For 300 nodes, the shortest delay is achieved when the number of retransmissions is set to 5.

When the number of nodes increased, the number of tolerable retransmissions decreases. FIG. 3C is a plot 320 illustrating the number of nodes or stations completing the Association procedures as a function of time when the total number of retransmission is varied. The total number of nodes, including the AP, is 500. When number of nodes increases to 500, the Association procedure is completed efficiently only when either no retransmission or only one retransmission is set. When the number of retransmissions is set to 2, only about 200 nodes can finish the association within 200 seconds. FIG. 3D is a plot 330 illustrating the number of nodes or stations completing the Association procedures as a function of time when the total number of retransmission is varied. The total number of nodes, including the AP, is 1000. FIG. 3D shows that when the total number of nodes or stations is 1000 or above, for example, 2000, even setting the number of retransmission to one causes excessive delay and less than 200 nodes can finish the Association procedure within 200 hundred seconds. FIG. 3E is a plot 340 illustrating the number of nodes or stations completing the Association procedures as a function of time when there is no retransmission. The total number of nodes, including the AP, is 2000. The Association procedure delay is about 80 seconds if the number of nodes is 2000 and number of retransmission is set to zero. The simulation results demonstrate that the existing standard cannot support large amount of nodes, such as 1000 or 2000 nodes, in association with a single AP.

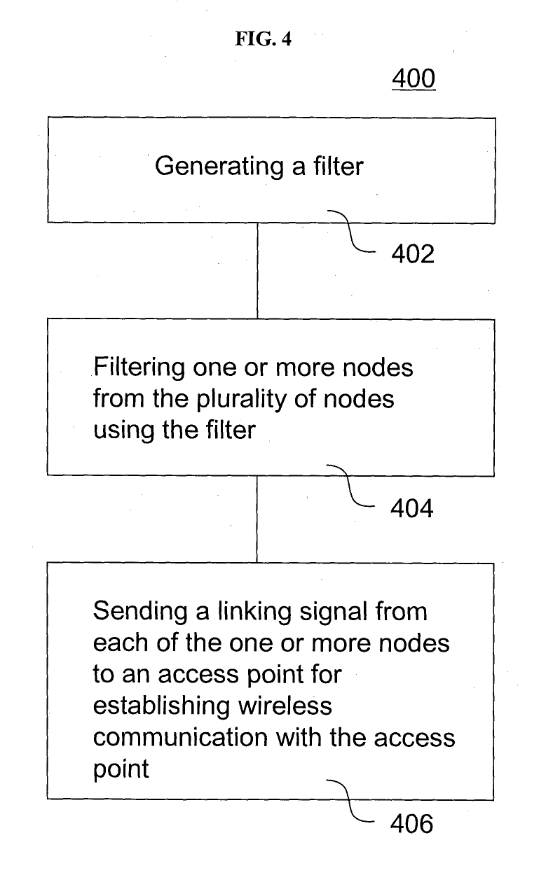

FIG. 4 is a schematic 400 illustrating a method according to various embodiments for controlling a wireless communication system. As shown in 402, the method may include defining or generating a filter. The method may further include as shown on 404, filtering one or more nodes from a plurality of nodes using the filter. The method may also include as shown in 406, sending a linking signal from each of the one or more nodes to an access point for establishing wireless communication with the access point 406.

In other words, a constraint is imposed on the plurality of nodes. A group of nodes is selected based on the constraint imposed to limit the nodes accessing the access point to a certain number. Each node from the group of nodes may then send a signal to the access point for establishing communication. Hence, only the group of nodes selected is allowed to communicate with the access point.

In this manner, the speed of wireless communication establishment between the access point and the nodes may be improved when the access point is in a vicinity of a large number of nodes.

In the present context, when the access point is in the vicinity of a number of nodes, it means that the number of nodes is within an area defined by a maximum range of the AP.

In various embodiments, the method may further include generating or defining subsequent filters, filtering subsequent one or more nodes from the plurality of nodes based on the subsequent filters and sending a linking signal from each of the subsequent one or more nodes to the access point for establishing wireless communication with the access point.

In other words, a subsequent constraint may be imposed on the plurality of nodes at a later time. A subsequent group of nodes may then be selected based on the subsequent constraint to limit the nodes accessing the access point to a certain number. Each node from the subsequent group of nodes may then send a signal to the access point for establishing communication. The nodes from the subsequent ground may or may not include nodes from the initial group.

In various embodiments, the method further includes determining after sending the linking signal, whether wireless communication between the one or more nodes and the access point has been established and resending subsequent linking signals from a part or all of the one or more nodes to the access point if wireless communications between the part or all of the one or more nodes has not been established.

In other words, after the linking signal is sent from the one or more nodes, a check is conducted on whether wireless communication between the access point and the one or more nodes has been established. If wireless communication has not been established, for example due to collisions, subsequent linking signals may be sent from the nodes out of the one or more nodes in which wireless communication with the access point have not been established. In various embodiments, the number of subsequent linking signals sent from the part or more of the one or more nodes to the access point may be based on network traffic.

In other words, the number of retransmissions from the filtered or selected nodes may be determined on the network traffic.

In various embodiments, sending the linking signal from each of the one or more nodes to the access point includes each of the one or more nodes sending an authentication request to the access point. In various embodiments, the linking signal is an authentication request.

In various embodiments, sending the linking signal from each of the one or more nodes to the access point includes each of the one or more nodes sending an association request to the access point. In various embodiments, the linking signal is an association request.

In various embodiments, generating or defining the filter includes generating or defining the filter to have a range of values falling between an upper limit and a lower limit. In various embodiments, generating or defining the filter includes defining or setting the filter to have a range of values falling between an upper limit and a lower limit. In various embodiments, having a range of values falling between an upper limit and a lower limit may include also both the upper limit and the lower limit.

In other words, a window having [Wₘᵢₙ, Wₘₐₓ] may be defined.

In various embodiments, generating or defining the filter includes generating or defining the filter to have a range of values falling above a limit. In other words, a window having [Wₘᵢₙ, ∞[may be defined. In various embodiments, generating or defining the filter includes generating or defining the filter to have a range of values falling below a limit. In other words, a window having [−∞, Wₘₐₓ[may be defined.

In various embodiments, filtering the one or more nodes from the plurality of nodes using the filter includes determining whether each of the plurality of nodes has a value that falls within the range of values. In other words, filtering the one or more nodes from the plurality of nodes includes determining whether each node has a value that falls within the window. If the value of the node does not fall within the range of values, the non-selected node or station will not send the linking signal or initiate the authentication or association procedures. The non-selected node may continue to scan for subsequent beacon or dedicated signals emitting from the AP conveying information on subsequent filters or windows.

In various alternative embodiments, filtering the one or more nodes from the plurality of nodes using the filter includes determining whether each of the plurality of nodes has a value that falls outside the range of values. In other words, filtering the one or more nodes from the plurality of nodes includes determining whether each node has a value that falls outside the window.

In various embodiments, defining or generating the filter is carried out in the access point.

In various embodiments, the method further includes conveying information on the filter from the access point to each of the plurality of nodes after defining the filter. In various embodiments, the information may be conveyed using a beacon signal or a dedicated signal. In other words, information on the filter may be attached to the beacon signal that the AP sends out periodically. Alternatively, the information on the filter may be sent via separate signaling messages.

In various embodiments, information on both the lower limit W₁ as well as the upper limit Wₘₐₓ is conveyed from the access point to each of the plurality of nodes.

In various embodiments, generating the filter includes setting the lower limit to a predefined fixed value and generating the upper limit. In various embodiments, the lower limit Wₘᵢₙ is set to a fixed value such as 0 and only information on the upper limit Wₘₐₓ is conveyed from the access point to each of the plurality of nodes.

In various alternate embodiments, generating the filter includes setting the upper limit to a predefined fixed value and generating the lower limit. On other words, alternatively, the upper limit Wₘₐₓ is set to a fixed value and only information on the lower limit Wₘᵢₙ is conveyed from the access point to each of the plurality of nodes.

In various embodiments, filtering the one or more nodes from the plurality of nodes using the filter may include obtaining the value for each of the plurality of nodes from a part of Media Access Control (MAC) address of the each of plurality of nodes.

In other words, each node has a unique MAC address. Each MAC address may have 6 bytes. Only when the MAC address or a part of the MAC address (such as the last few bytes) falls within the range of values, the node in which the MAC address is associated is filtered or selected. The filtered or selected node may send a linking signal to the access point.

In various embodiments, the value may be obtained from an identification number or part of an identification number or a parameter of each node.

Alternatively, filtering the one or more nodes from the plurality of nodes using the filter may include obtaining the value for each of the plurality of nodes by generating a number in each of the plurality of nodes.

The upper limit and the lower limit of the filter may be selected such that the MAC address or the part of the MAC address or the identification number or the part of the identification number or the parameter or the random number of at least one node of the plurality of nodes falls within the range of values between the upper limit and the lower limit.

In various embodiments, filtering the one or more nodes from the plurality of nodes using the filter is carried out in each of the nodes.

Information on the filter may be transmitted from the access point to each of the plurality of nodes using a beacon signal or a dedicated signal after defining the filter. Each of the node may determine whether the MAC address or a part of the MAC address or an identification number or part of an identification number or a parameter characteristic of each or some of the nodes falls within the range of values defined by the filter. For each node in which the MAC address or a part of the MAC address or an identification number or part of an identification number or a parameter or a random number representing each node falls within the range of values defined by the filter, the node may send a linking signal to the access point.

For instance, a 6-bytes MAC address may be used to determine whether a node is allowed to perform authentication and association with a given AP. The AP may use part of the MAC address, such as the last byte, to determine whether a node should send in its authentication/association request. A window [Wₘᵢₙ, Wₘₐₓ] may be defined to control the access. Only if the value of desired part of the MAC address (such as the last byte) for a given node falls in the window, then the node is allowed to send an authentication request to the AP. If authentication has already finished but association procedure has not been finished yet, then the constraint of MAC filtering may or may not apply.

In various embodiments, defining the filter includes determining conditions such as network traffic involving the access point and adjusting the filter based on the conditions such as the network traffic. In other words, Wₘᵢₙ or Wₘₐₓ or both Wₘᵢₙ and Wₘₐₓ may be adjustable based on conditions such as network traffic. The filter size may be decreased when there are many nodes in the vicinity of the AP trying to access the AP. This will reduce the number of nodes trying to establish communication with the AP at one time, which may lead to overall reduction in delay and improvement in speed. On the other hand, the filter size may be increased if there are not many nodes in the vicinity of the AP trying to access the AP. These ensure that more nodes are able to establish communication with the AP at one time, leading to overall reduction in delay and improvement in speed. In other words, adjusting the filter may advantageously allow an optimum number of nodes to establish communication with the AP at one time, leading to overall efficiency and improvement in speed.

In various embodiments, determining the network traffic includes determining amount of at least one of data or management data in the access point awaiting to be processed. Data usually refers to the data packet from upper layers such as application, transport or network layers. Management data refers to those packets generated by MAC protocol and usually is place in a separate queue and has a higher priority. In other words, the queue size of management messages may be used as an indicator for network traffic.

In various embodiments, determining network traffic includes determining amount of at least one of data or management data in the access point processed. In other words, the historic size of the queue length of management messages may be used as an indicator for network traffic.

An algorithm to adjust the filter or window size according to various embodiments is as below:

```
Init:
    All values are integers.
    Wₘᵢₙ = 0; Wₘₐₓ = 255; Q0 = predefined values;
    ΔW = predefined values; Bchanged = FALSE; Qaverage = 0;
    Qm = length of queue for management signaling;
    Qaverage = Qaverage*2/3 + Qm*1/3
    if Qm > Q0 then
        if Wₘₐₓ == 255 && Bchanged == FALSE then
            Wₘₐₓ = ΔW or other initial values;
            Bchanged = TRUE;
        else
            if ΔW > 2 then
                ΔW = ΔW/2;
                    endif
        if Wₘₐₓ > ΔW then
            Wₘₐₓ = Wₘₐₓ − ΔW;
            endif
          endif
        else if Wₘₐₓ < 255 then
        if Wₘₐₓ < (255 − ΔW) then
            Wₘₐₓ = Wₘₐₓ + ΔW;
        else
            Wₘₐₓ = 255;
            endif
        if Qaverage == 0 then
            ΔW = ΔW + 2;
            endif
        endif
```

This algorithm periodically determines Qm, the current queue length for management signaling. An average queue length, Qaverage is then updated based on the Qm as well as the previous average queue length. If the current Qm is greater than a predetermined value, Q0, the algorithm will decrease the window size by decreasing Wₘₐₓ by halving ΔW (ΔW=ΔW/2) provided ΔW>2. If Wₘₐₓ has not been adjusted before (ie. Wₘₐₓ==255 && Bchanged==FALSE), then Wₘₐₓ is set to a predetermined value (ie. ΔW=predefined values). Otherwise, Wₘₐₓ is decreased by ΔW. ΔW is adjusted in different iterations of the algorithm. If the current Qm is less than or equal to Q0, the window size will be increased by increasing Wₘₐₓ, up to a maximum size of 255. If the average queue size is 0, ΔW will be increased by 2. This is repeated in each iteration.

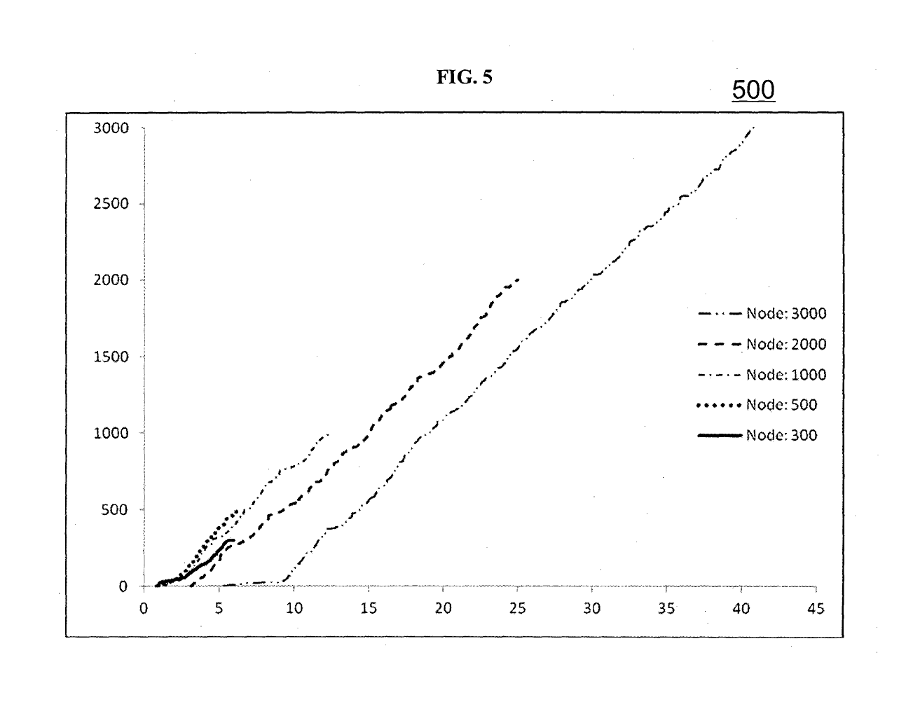

Simulation is carried out for a communication system using MAC address filtering under IEEE 802.11 standard. In the simulation, Q0 is set to 5 and ΔW is set to 5. The total number of nodes is varied as 300, 500, 1000, 2000 and 3000. The number of retransmissions is set to 7. FIG. 5 is a plot 500 illustrating according to various embodiments the number of nodes or stations completing the Authentication and Association procedures using MAC address filtering according to various embodiments as a function of time when the total number of nodes or stations are varied. In all scenarios, the stations can finish the association within reasonable time duration.

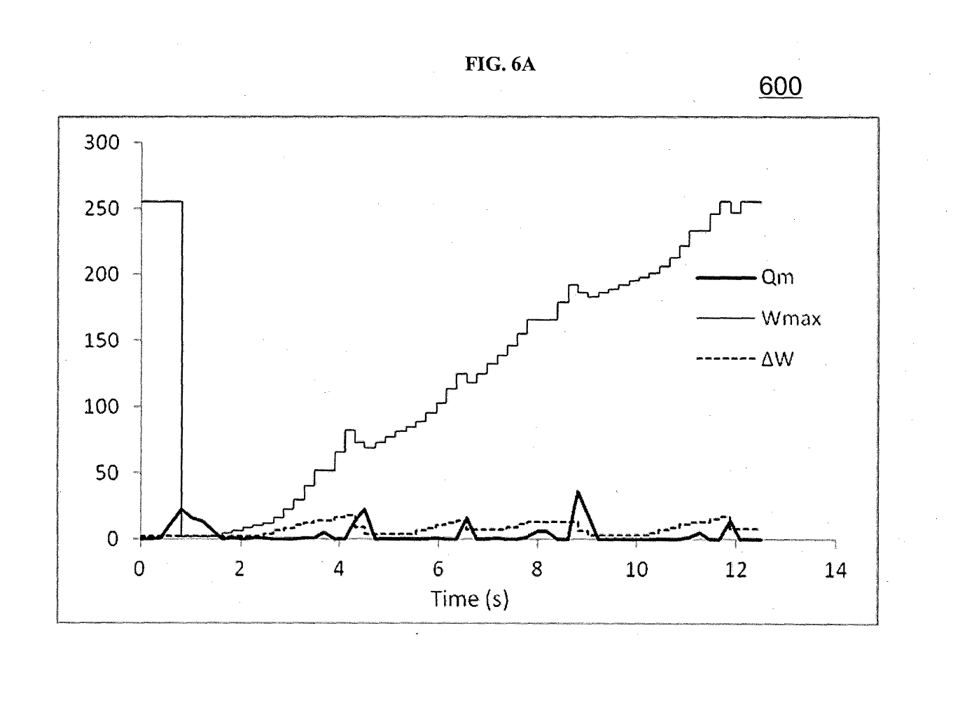

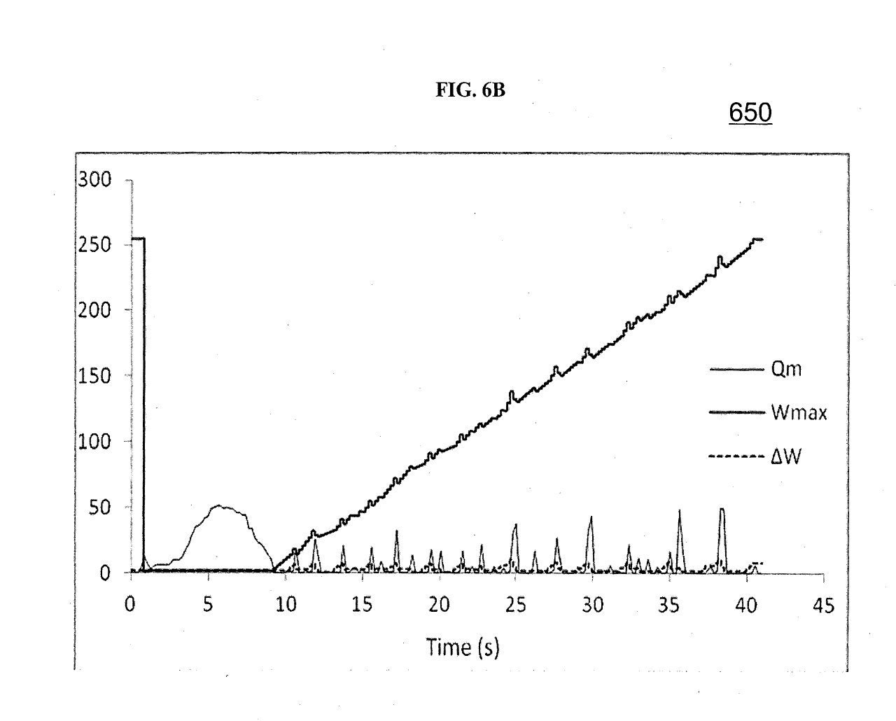

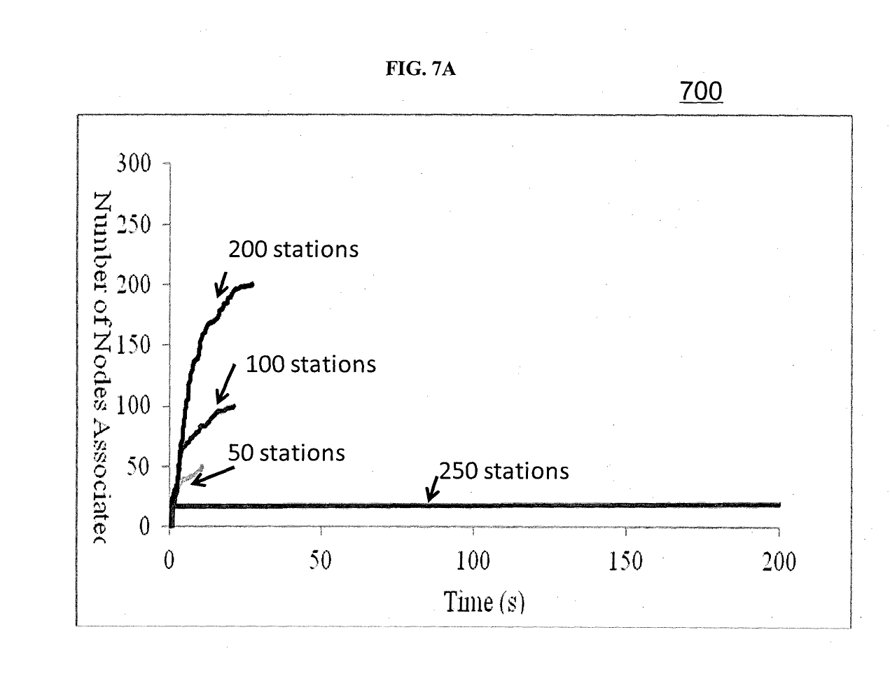

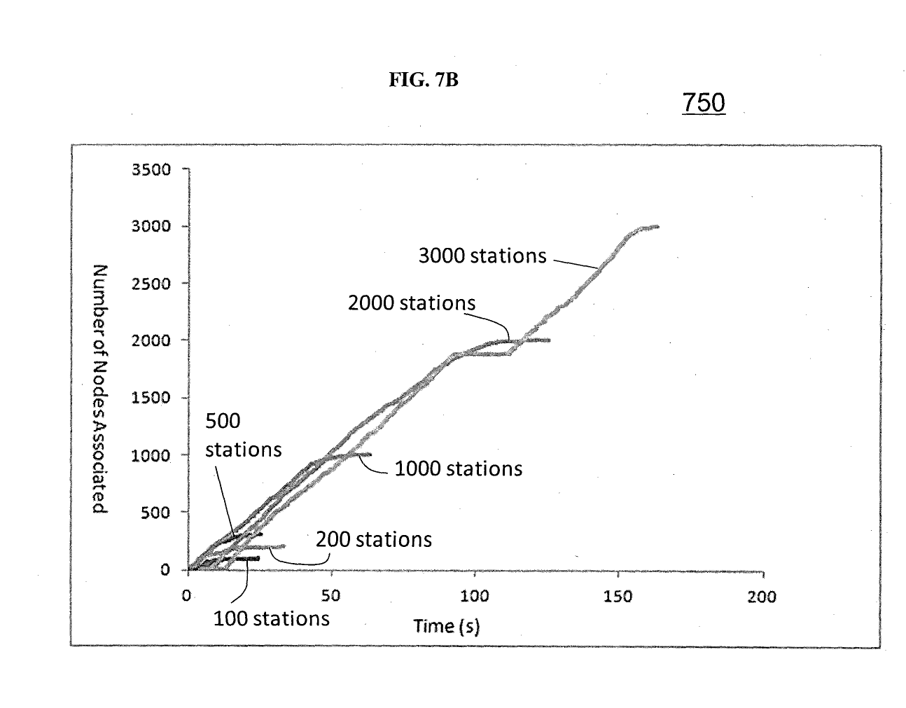

FIG. 6A is a plot 600 illustrating shows the variation of the Qₘ, Wₘₐₓ and ΔW as a function of time for a communication system employing MAC address filtering according to various embodiments when the total number of nodes, including the AP, is fixed at 1000. FIG. 6B is a plot 650 illustrating shows the variation of the Qₘ, Wₘₐₓ and ΔW as a function of time for a communication system employing MAC address filtering according to various embodiments when the total number of nodes, including the AP, is fixed at 3000. FIG. 7A is a plot 700 illustrating the number of nodes or stations completing the Authentication and Association procedures under IEEE 802.11-2007 as a function of time when the total number of nodes or stations are varied. After modifying the PHY and MAC features based on the current framework of 802.11 ah, the maximum number of stations that can be supported by the current standard found to below 250 stations due to the collisions. The number is far below the number of 6000 stations required. FIG. 7B is a plot 750 illustrating the number of nodes or stations completing the Authentication and Association procedures using random number filtering according to various embodiments as a function of time when the total number of nodes or stations are varied. The number of nodes or stations, including the AP, is varied from 50 to 3000. FIG. 7B shows that even if the number of nodes or stations is increased to 3000, all the nodes or stations can finish the association within 200 seconds.

Based on the simulation results illustrated by FIGS. 5, 6A-6B and 7A-7B, it may be concluded that MAC filtering for Authentication/Association controlling may assist communication systems employing IEEE 802.11 standard to support large number of nodes.

To support up to 6000 nodes, Wₘₐₓ may be set initially to 85 instead of 255 and the number of retransmissions for authentication/association may be set to 3 or 4.

Advantageously, the implementation of MAC filtering is simple and only requires the AP to broadcast a few control values such as the window or filter size as well as the number of retransmission shall be used for authentication/association request. Two bytes may be sufficient to carry the information.

In various embodiments, filtering the one or more nodes from the plurality of nodes using the filter further includes obtaining the value for each of the plurality of nodes by generating a number in each of the plurality of nodes. In various embodiments, the number is a random number.

In various embodiments, the number is generated in each of the plurality of nodes. Instead of using the MAC address, a node may generate a random number, R, and use the random number as a reference to compare with the filter or window conveyed by the AP. If the values falls in the window (ie. Wmin<=R<=Wmax), the node is allowed to transmit the authenticate request. Otherwise, it would not transmit the authenticate request. In other words, the node may transmit a linking signal such as an authentication request when the random number it generates falls within the range of values falling between an upper limit and a lower limit broadcasted by the AP. An association request may or may not be limited by the above constraint.

The random number may be generated when a node is turned on. Another random number may be regenerated after a fixed period or before the node send out the authentication request.

In various embodiments, the AP may not convey information on the filter or window if the filter or window reaches a maximum size. In various embodiments, determining whether filtering is required may be done before filtering is carried out or information on the filter is conveyed from the access point to each of the plurality of nodes using a beacon signal or dedicated signal.

In various embodiments, the AP may convey information on an AP generated number RND_TH (any integer number between a lower threshold, RND_MIN and an upper threshold, RND_MAX, where for example RND_MIN can be 0 and RND_MAX can be 255) in a beacon signal or any suitable control signals or dedicated signals to each of the nodes. To determine whether it can start the process of authentication and authorization, the node may generate a random number RND_I in between the lower threshold, RND_MIN and the upper threshold, RND_MAX. The random number may be generated uniformly or following other distributions.

In various embodiments, the lower threshold, RND_MIN, is the lower limit and the AP generated number, RND_TH, is the upper limit. In various embodiments, generating the filter includes setting the lower limit to a predefined fixed value and generating the upper limit. In other words, in various embodiments, the lower limit is fixed and the upper limit is a number generated by the access point. If a node generates a random number that is larger than the AP generated number, RND_TH, it may not be allowed to send the linking signal and have to delay the authentication and association procedures. On the other hand, if the random number falls within a range of values between the lower limit, RND_MIN, and the upper limit, RND_TH, the node may proceed to send a linking signal to the AP.

The AP generated number RND_TH may vary with the network traffic (for instance the predicted/estimated load due to the contention of concurrent authentication and association requests).

In various embodiments, the upper limit (ie. the AP generated number RND_TH) generated is inversely proportional to the number of plurality of nodes. In various embodiments, the upper limit is inversely proportional to the estimated number of plurality of nodes unable to complete authentication or association procedures. In various embodiments, further transmitting information signal indicating the upper limit, the upper limit generated by the access point, from the access point to each of the plurality of nodes.

When the AP is in a vicinity of a small number of nodes, the AP generated number RND_TH may be set as a larger number so that more nodes fall within the range of values between the lower limit and the upper limit. As a result, more nodes may start to send a linking signal or initiate authentication or association procedures to establish wireless communication between the AP and the nodes. Conversely, when the AP is in a vicinity of a large number of nodes, the AP generated number RND_TH may be set as a lower number so that less nodes fall within the range of values between the lower limit and the upper limit. As a result, fewer nodes may start to send a linking signal or initiate authentication or association procedures to establish wireless communication between the AP and the nodes. In various embodiments, the upper limit is directly proportional to the beacon time interval.

In this approach, the decision on whether to send a linking signal or initiate authentication or association procedures is based on the AP generated number RND_TH and the random number RND_I rather than MAC address of the nodes. The AP may adjust the number according to the algorithm shown below:

```
Init:
    RND_MIN = 0;
    RND_MAX = 255;
    RND_DEF = some predefined value;
    T_BI = Beacon Interval;
    N_MAX = estimated max no. of nodes doing authentication/
    association;
    Delta = the factor reflecting the contention degree;
    Beta = dampening factor;
    T_AVG = Average Time to complete authentication/association;
    N_AVG = T_BI/T_AVG;
    N_R = estimated max no. of nodes yet to do authentication/
    association;
    if N_R / N_AVG > Delta then
      RND_TH = Beta * N_AVG/ N_R;
    Else
      RND_TH = RND_DEF;
      endif
```

In the above algorithm, the average time, T_AVG, to complete authentication or association procedures is determined. The average number of nodes, N_AVG, which can complete authentication or association procedures between beacon signals time interval is calculated based on T_AVG. The estimated number of nodes yet to complete authentication or association procedures, N_R, is also determined. If the ratio of N_R to N_AVG exceeds a predetermined threshold, delta, RND_TH is calculated based on N_R and N_AVG. RND_TH is inversely proportional to the estimated number of nodes yet to complete authentication or association procedures. Otherwise, RND_TH is set to a predefined value (RND_DEF). The maximum number of nodes, N_MAX, may be known or estimated when the network is deployed. This information can be used to initialize the number RND_TH. T_AVG may be estimated or based on the measurement during the beacon intervals.

In various embodiments, the upper threshold, RND_MAX, is the upper limit and the AP generated number, RND_TH, is the lower limit. In various embodiments, generating the filter includes setting the upper limit to a predefined fixed value and generating the lower limit. In other words, in various embodiments, the upper limit is fixed and the lower limit is a number generated by the access point.

In various embodiments, the lower limit generated is directly proportional to the number of plurality of nodes. When the AP is in a vicinity of a small number of nodes, the AP generated number RND_TH may be set as a lower number so that more nodes fall within the range of values between the lower limit and the upper limit. As a result, more nodes may start to send a linking signal or initiate authentication or association procedures to establish wireless communication between the AP and the nodes. Conversely, when the AP is in a vicinity of a large number of nodes, the AP generated number RND_TH may be set as a higher number so that less nodes fall within the range of values between the lower limit and the upper limit. As a result, less nodes may start to send a linking signal or initiate authentication or association procedures to establish wireless communication between the AP and the nodes. In various embodiments, the lower limit is inversely proportional to the beacon time interval.

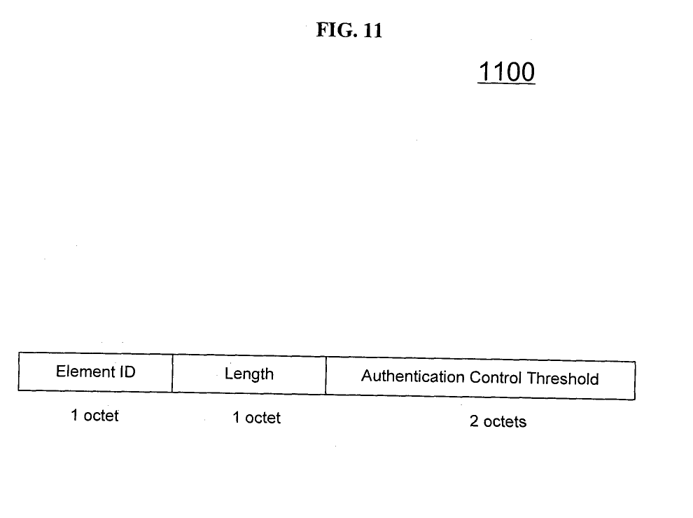

In various embodiments, the AP generated number may be referred to as the Authentication Control Threshold. In various embodiments, the AP generated number may vary from 0 to 65535. In other words, the lower threshold RND_MIN may be 0 and the upper threshold RND_MAX may be 65535. In various embodiments, an authentication control information element (IE) comprising the Authentication Control Threshold may be sent from the AP to each of the plurality of nodes. In various embodiments, the authentication control information element (IE) may be sent in a beacon signal from the AP to each of the plurality of nodes. FIG. 11 shows an illustration of an authentication control information element (IE). As shown in FIG. 11, the field indicating the element identification number takes up one octet. The field indicating the element length takes up one octet. The information field of the information element may only consist of the Authentication Control Threshold. The Authentication Control Threshold takes up two octets. After receiving the Authentication Control IE, each of the plurality of nodes may extract the value of the Authentication Control Threshold and compare it with the random number generated by each node. In various embodiments, the lower threshold, RND_MIN, is the lower limit and the Authentication Control Threshold is the upper limit. If the random number generated by the node is less than or equal to the Authentication Control Threshold (ie. falls within the range of values between RND_MIN and the Authentication Control Threshold), the node may transmit a linking signal to the AP. If the random number is more than the Authentication Control Threshold, it may not transmit a linking signal to the AP. In various embodiments, the linking signal includes the authentication request. In various embodiments, the linking signal does not include the association request. In various embodiments, the Authentication Control Threshold defines the filter or window (ie. is the upper limit or alternatively, the lower limit) for a predefined period of time. A subsequent Authentication Control Threshold which may have another value may be generated upon the expiry of the predefined period of time. In various embodiments, a subsequent authentication control information element (IE) including the subsequent Authentication Control Threshold may be sent from the AP to each of the plurality of nodes. In various embodiments, the subsequent authentication control information element (IE) may be sent in a beacon signal from the AP to each of the plurality of nodes.

In various embodiments, filtering may be regarded as a selection process in which the access point defines or determines filtering parameters (eg. upper limit or lower limit) and sends to the nodes or stations. Each node or station in the vicinity of the AP may receive the filtering parameters and use the filtering parameters with a value generated by the node or station according to a selection function to see whether the node or station is allowed to send the linking signal. A selection function may be agreed under a standard to govern the operation of the AP and nodes or stations. The selection function may be referred to as a filtering rule or a filtering function. In various embodiments, the filtering rule or filtering function may be pre-determined or predefined. Filtering parameters (such as information on a filter eg. upper limit or lower limit) given by the access point and a value (random number or partial MAC address) generated by the node or station may be used as inputs in the filtering rule or filtering function to determined whether the node or station should send a linking signal to the AP. In other words, the filtering rule may include, for example, information such as whether to use random number generation or MAC address, whether to use the lower limit or upper limit or both the lower and upper limits to adjust the filter or window.

In various embodiments, the method further includes each of the plurality of nodes receiving information on a pre-determined filtering rule from the access point. In other words, the access point may send each of the plurality of nodes information on the pre-determined filtering rule. In various embodiments, the method further includes filtering the one or more nodes from the plurality of nodes using the pre-determined filtering rule.

In various embodiments, sending the linking signal from each of the one or more nodes to the access point for establishing wireless communication with the access point includes sending the linking signal from each of the one or more nodes to the access point for establishing wireless communication with the access point, the filtering of the one or more nodes from the plurality of nodes to send the linking signal based on the pre-determined filtering rule and filter.

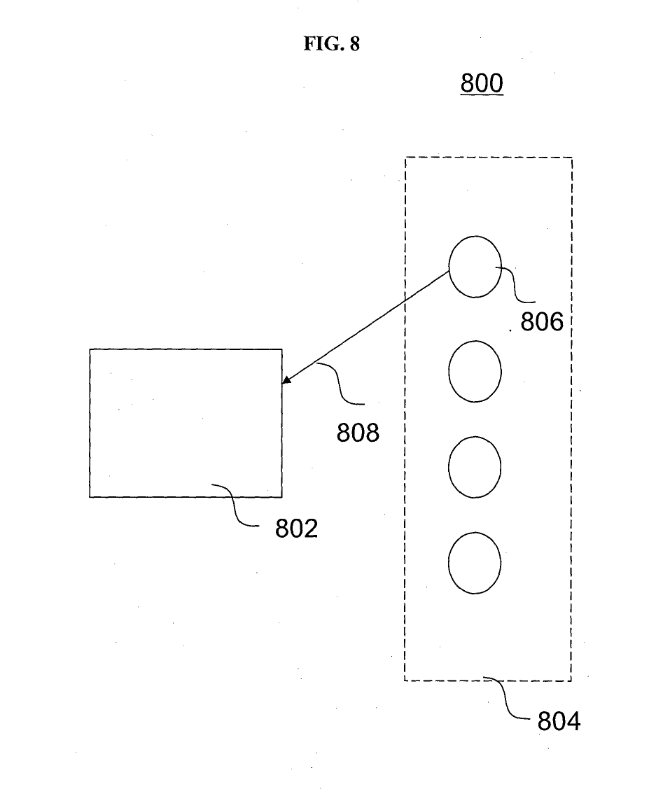

In various embodiments, sending the linking signal to the access point for establishing wireless communication with the access point provided that the one or more nodes is determined to send the linking signal includes starting to send the linking signal to the access point based on the received information and the filtering rule, sending the linking signal to the access point for establishing wireless communication with the access point, the filtering of the one or more nodes from the plurality of nodes to send the linking signal based on the pre-determined filtering rule and filter. FIG. 8 is a schematic 800 illustrating a wireless communication system according to various embodiments. According to various embodiments, a wireless communication system may be provided including an access point 802 for generating a filter and a plurality of nodes 804, wherein the system is configured such that one or more nodes 806 is filtered from the plurality of nodes 804 and each of the one or more nodes 806 is configured to send a linking signal 808 to the access point 802 for establishing wireless communication with the access point 802.

In various embodiments, the filter may have a range of values falling between an upper limit and a lower limit.

In various embodiments, a range of values falling between an upper limit and a lower limit may include also both the upper limit and the lower limit.

In other words, a window having [Wₘᵢₙ, Wₘₐₓ] may be defined.

In various embodiments, a range of values falling above a limit. In other words, a window having [Wₘᵢₙ, ∞[may be defined. In various embodiments, a range of values falling below a limit. In other words, a window having [−∞, Wₘₐₓ[may be defined.

In various embodiments, each of the plurality of nodes will have a value representing the node. In various embodiments, at least one node of the plurality of nodes will fall within the range of values between the upper limit and the lower limit.

In various embodiments, the value of each node is the MAC address or part of the MAC address of each node. In various embodiments, the value of each node is the identification number or part of the identification number of each node. In various embodiments, the value is a number randomly generated by each node.

In various embodiments, the filter or window is an adjustable filter or window. In other words, the filter or window is configured to be adjustable, ie. the upper limit or lower limit or both the upper and lower limits may be varied. In various embodiments, the adjustable filter or window is adjustable based on network traffic. In various embodiments, the adjustable filter or window may be adjusted based on the amount of at least one of data or management data, in the access point awaiting to be processed or the amount of at least one of data or management data in the access point processed or a combination of the amount of at least one of data or management data in the access point awaiting to be processed and already processed.

In various embodiments, the communication system or access point is configured such that the filter or window is adjustable based on determination of network traffic. The determination of network traffic may be based on the amount of at least one of data or management data in the access point awaiting to be processed or the amount of at least one of data or management data in the access point processed or a combination of the amount of at least one of data or management data in the access point awaiting to be processed and the amount of at least one of data or management data in the access point processed.

In various embodiments, the filter or the window may be defined by the access point. In various embodiments, information on the filter or the window may be conveyed from the access point to each of the plurality of nodes. In various embodiments, the information on the filter or the window may be conveyed by a beacon signal or a dedicated signal or a control signal.

In various embodiments, the lower limit of the filter or the window may be a predefined fixed limit. The upper limit may be generated by the access point. In various embodiments, information on the upper limit may be conveyed from the access point to each of the plurality of nodes via a beacon signal or dedicated signal or control signal. In various embodiments, the upper limit is inversely proportional to the number of plurality of nodes.

In various embodiments, the upper limit of the filter or the window may be a predefined fixed limit. The lower limit may be generated by the access point. In various embodiments, information on the lower limit may be conveyed from the access point to each of the plurality of nodes via a beacon signal or a dedicated signal or a control signal. In various embodiments, the lower limit is proportional to the number of plurality of nodes.

In various embodiments, each of the plurality of nodes is configured to receive information on the filter or window. In various embodiments, each of the plurality of nodes is configured to determine whether the node has a value that falls within the range of values between the upper limit and the lower limit. In various embodiments, each of the plurality of nodes has a processor or circuit or means configured to determine whether the node has a value that falls within the range of values. In various embodiments, each of the plurality of nodes is configured to determine whether it may send a linking signal to the access point based on whether the nodes has a value that falls within the range of values between the upper limit and the lower limit. In various embodiments, each node is configured to determine after sending the linking signal whether wireless communications between the node and the access point has been established. Each node is then configured to resend subsequent linking signals from the node if wireless communication between the node and the access point has not been established. In other words, if the node has been selected, ie. filtered from the plurality of nodes, the node may be configured to check whether wireless communication between the node and the access point has been established. In the event that wireless communication between the node and the access point has not been established, the node may send subsequent linking signals to the access point for establishing wireless communications. In various embodiments, the number of subsequent linking signals sent from the node may be based on network traffic involving the access point.

In various embodiments, the linking signal may be an authentication request or an association request.

In various embodiments, subsequent filters may be defined. Subsequent one or more nodes from the plurality of nodes may be filtered based on the subsequent filters. Each of the subsequent one or more nodes may send a linking signal to the access point for establishing wireless communication with the access point.

In other words, a filter may be defined. One or more nodes may be filtered from the plurality of nodes based on the filter. The one or more nodes are then allowed to send a linking signal to the access point for establishing communication.

In various embodiments, the access point may be further configured to generate a pre-determined filtering rule.

In various embodiments, the system being configured such that one or more nodes is filtered from the plurality of nodes and each of the one or more nodes is configured to send a linking signal to the access point for establishing wireless communication with the access point may include the system being configured such that one or more nodes is filtered from the plurality of nodes and each of the one or more nodes is configured to send a linking signal to the access point for establishing wireless communication with the access point, the filtering of the one or more nodes from the plurality of nodes based on the filter and the pre-determined filtering rule.

In various embodiments, the system being configured such that one or more nodes is filtered from the plurality of nodes and each of the one or more nodes is configured to send a linking signal to the access point for establishing wireless communication with the access point, the filtering of the one or more nodes from the plurality of nodes based on the filter and the pre-determined filtering rule may include the system being configured such that one or more nodes is filtered from the plurality of nodes and each of the one or more nodes is configured to start sending a linking signal to the access point, the filtering of the one or more nodes from the plurality of nodes based on the filter and the pre-determined filtering rule.

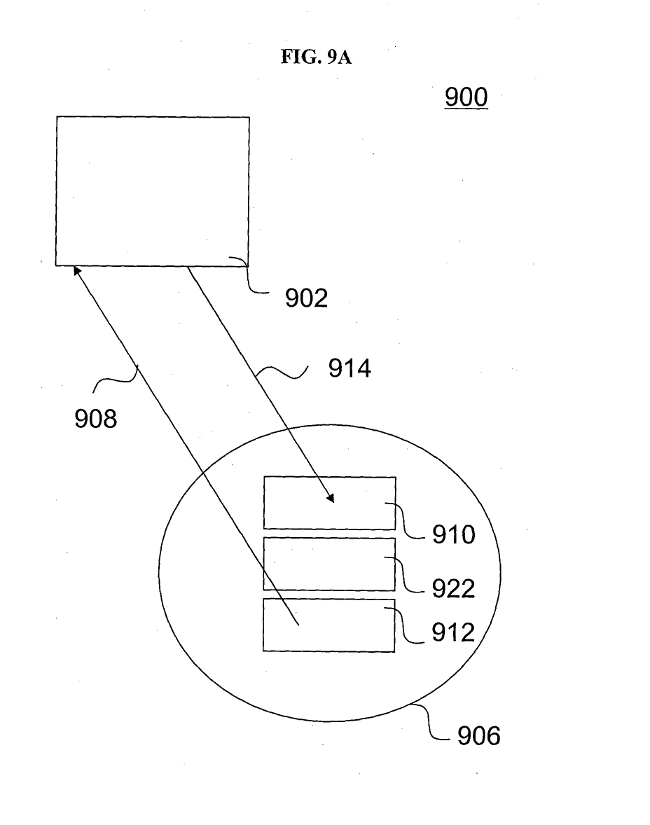

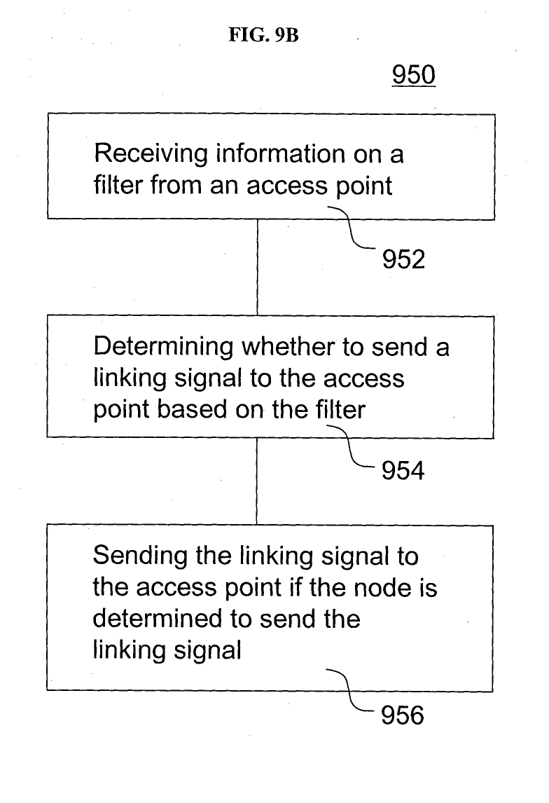

FIG. 9A is a schematic 900 illustrating a node 906 according to various embodiments for wireless communication with an access point 902. In various embodiments, a node 906 including a receiver 910 configured to receive information 914 on a filter from the access point 902 may be provided. The node 906 may have a determination circuit 922 configured to determine whether to send a linking signal to the access point 902 based on the filter. The node 906 may also include a transmitter 912 configured to send a linking signal 908 to the access point 902 for establishing wireless communication with the access point 902 if the node 906 is determined (by the determination circuit; the determination circuit configured to determine whether to send a linking signal to the access point based on the filter) to send the linking signal 908. A transmitter may be referred to as a transmitting circuit. A receiver may be referred to as a receiving circuit.

In various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with alternative embodiments.

FIG. 9B is a schematic 950 illustrating a method according to various embodiments for controlling a node in the establishment of communication with an access point. According to various embodiments, in 952, a method including receiving information on a filter from an access point is provided. The method may further include in 954, determining whether to send a linking signal to the access point based on the filter, and in 956, sending the linking signal to the access point for establishing wireless communication with the access point if the node is determined (by the node) to send the linking signal.

In various embodiments, the filter has a range of values falling between an upper limit and a lower limit.

In various embodiments, the filter has a range of values falling above a limit. In various embodiments, the filter has a range of values falling below a limit.

In various embodiments, wherein determining whether to send a linking signal to the access point based on the filter includes determining whether the node has a value that falls within the range of values.

In various embodiments, wherein determining whether the node has a value that falls within the range of values includes obtaining the value from a part of Media Access Control (MAC) address of node.

In various embodiments, wherein determining whether the node has a value that falls within the range of values includes obtaining the value by randomly generating a number.

In various embodiments, wherein the linking signal includes an authentication request.

In various embodiments, wherein the linking signal includes an association request.

In various embodiments, the method further includes receiving information on a pre-determined filtering rule. In various embodiments, the method further includes determining whether to send the linking signal to the access point based on the pre-determined filtering rule.

In various embodiments, sending the linking signal to the access point for establishing wireless communication with the access point if the node is determined to send the linking signal includes sending the linking signal to the access point for establishing wireless communication with the access point if the node is determined to send the linking signal based on the pre-determined filtering rule and filter.

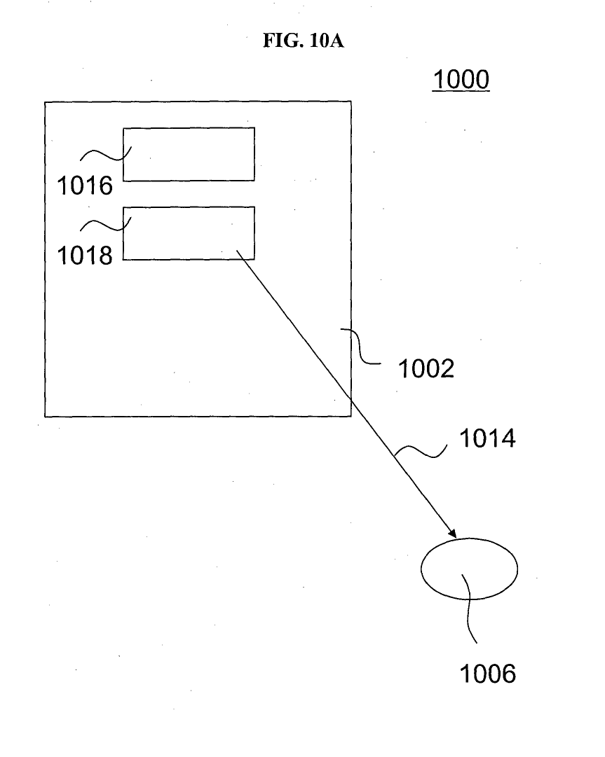

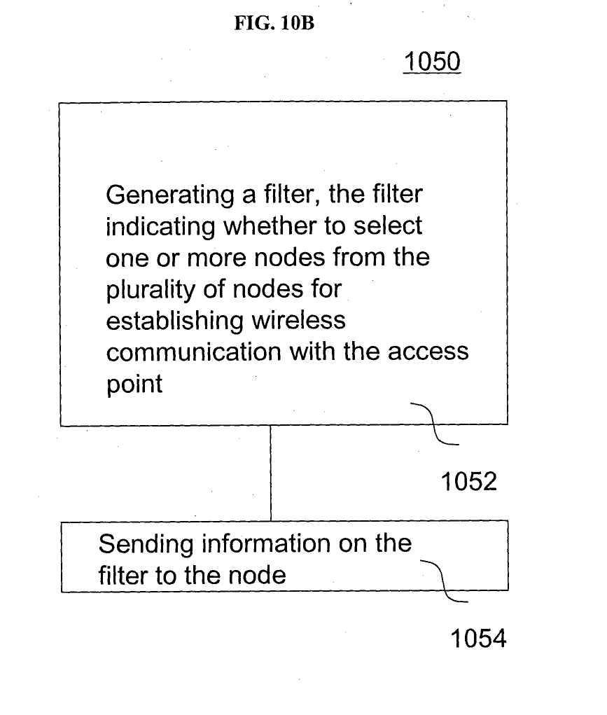

In various embodiments, sending the linking signal to the access point for establishing wireless communication with the access point if the node is determined to send the linking signal based on the pre-determined filtering rule and filter includes starting to send the linking signal to the access point for establishing wireless communication with the access point if the node is determined to send the linking signal based on the pre-determined filtering rule and filter. FIG. 10A is a schematic 1000 illustrating an access point 1002 according to various embodiments for wireless communication with a node 1006. In various embodiments, an access point 1002 including a processor or generating circuit 1016 configured to generate a filter, the filter indicating whether to select one or more nodes from the plurality of nodes for establishing wireless communication with the access point may be provided. The access point 1002 may also include a transmitter 1018 configured to send information 1014 on the filter to each of the plurality of nodes. In various embodiments, the information may be sent in a signal such as a beacon signal or specialized signal or control signal. A transmitter may also be referred to as a transmitting circuit.

In various embodiments, the access point further including a receiver configured to receive a linking signal from the node if the node is determined to establish wireless communication with the access point based on the filter. A receiver may also be referred to as a receiving circuit.

FIG. 10B is a schematic 1050 illustrating a method according to various embodiments for controlling an access point. According to various embodiments, in 1052, a method including generating a filter, the filter indicating whether to select one or more nodes from the plurality of nodes for establishing wireless communication with the access point may be provided. In 1054, the method may further include sending information on the filter to each of the plurality of nodes.

In various embodiments, the method further includes receiving a linking signal from the node if the node is determined to establish wireless communication with the access point based on the filter

In various embodiments, generating the filter includes defining the filter to have a range of values falling between an upper limit and a lower limit.

In various embodiments, wherein generating the filter includes setting the lower limit to a predefined fixed value and generating the upper limit.

In various embodiments, wherein generating the filter includes setting the upper limit to a predefined fixed value and generating the lower limit.

In various embodiments, generating the filter includes defining the filter to have a range of values falling above a limit. In various embodiments, generating the filter includes defining the filter to have a range of values falling below a limit.

In various embodiments, wherein generating a filter includes determining network traffic involving the access point and adjusting the filter based on the network traffic.

In various embodiments, wherein determining the network traffic includes determining amount of at least one of data or management data in the access point awaiting to be processed.

In various embodiments, wherein determining the network traffic includes determining amount of at least one of data or management data in the access point processed.

In various embodiments, the filter includes a predetermined filtering rule. In various embodiments, the method further includes sending information on the filtering rule to the each of the plurality of nodes.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A method for controlling a node, the method comprising:
receiving information on a filter from an access point;
determining whether to send a linking signal to the access point based on the filter; and
sending the linking signal to the access point for establishing wireless communication with the access point if the node is determined to send the linking signal.

2. The method according to claim 1 further comprising receiving information on a pre-determined filtering rule.

3. The method according to claim 2 further comprising determining whether to send the linking signal to the access point based on the pre-determined filtering rule.

4. The method according to claim 3, wherein sending the linking signal to the access point for establishing wireless communication with the access point if the node is determined to send the linking signal comprises sending the linking signal to the access point for establishing wireless communication with the access point if the node is determined to send the linking signal based on the pre-determined filtering rule and filter.

5. The method according to claim 4, wherein sending the linking signal to the access point for establishing wireless communication with the access point if the node is determined to send the linking signal based on the pre-determined filtering rule and filter comprises starting to send the linking signal to the access point for establishing wireless communication with the access point if the node is determined to send the linking signal based on the pre-determined filtering rule and filter.

6. The method according to claim 1, wherein the filter has a range of values falling between an upper limit and a lower limit.

7. The method according to claim 6, wherein determining whether to send a linking signal to the access point based on the filter comprises determining whether the node has a value that falls within the range of values.

8. The method according to claim 7, wherein determining whether the node has a value that falls within the range of values comprises obtaining the value from a part of Media Access Control (MAC) address of node.

9. The method according to claim 7, wherein determining whether the node has a value that falls within the range of values comprises obtaining the value by randomly generating a number.

10. The method according to claim 1, wherein the linking signal comprises an authentication request.

11. The method according to claim 1, wherein the linking signal comprises an association request.

12. A node comprising:
a receiver configured to receive information on a filter from an access point;
a determination circuit configured to determine whether to send a linking signal to the access point based on the filter; and
a transmitter configured to send the linking signal to the access point for establishing wireless communication with the access point if the node is determined to send the linking signal.

13. A method for controlling an access point, the method comprising:
generating a filter, the filter indicating whether to select one or more nodes from the plurality of nodes for establishing wireless communication with the access point; and
sending information on the filter to each of the plurality of nodes.

14. The method according to claim 13, the method further comprising:
receiving a linking signal from the node if the node is determined to establish wireless communication with the access point based on the filter.

15. The method according to claim 14, wherein generating the filter comprises:
defining the filter to have a range of values falling between an upper limit and an lower limit.

16. The method according to claim 15, wherein generating the filter comprises:
setting the lower limit to a predefined fixed value and generating the upper limit.

17. The method according to claim 15, wherein generating the filter comprises:
setting the upper limit to a predefined fixed value and generating the lower limit.

18. The method according to claim 13, wherein generating a filter comprises determining network traffic involving the access point and adjusting the filter based on the network traffic.

19. The method according to claim 18, wherein determining the network traffic comprises determining amount of at least one of data or management data in the access point awaiting to be processed.

20. The method according to claim 18, wherein determining the network traffic comprises determining amount of at least one of data or management data in the access point processed.

21. An access point comprising:
a generating circuit configured to generate a filter, the filter indicating whether to select one or more nodes from the plurality of nodes for establishing wireless communication with the access point; and
a transmitter configured to send information on the filter to each of the plurality of nodes.

22. The access point according to claim 21, further comprising:
a receiver configured to receive a linking signal from the node if the node is determined to establish wireless communication with the access point based on the filter.

23. A method for controlling a wireless communication system comprising:
generating a filter;
filtering one or more nodes from a plurality of nodes using the filter; and
sending a linking signal from each of the one or more nodes to the access point for establishing wireless communication with an access point.

24. The method according to claim 23, wherein generating the filter is carried out in the access point.

25. The method according to claim 23, further comprising:
conveying information on the filter from the access point to each of the plurality of nodes after defining the filter.

26. The method according to claim 23, wherein filtering the one or more nodes from the plurality of nodes using the filter is carried out in each of the nodes.

27. A wireless communication system comprising:
an access point for generating a filter; and
a plurality of nodes;
wherein the system is configured such that one or more nodes is filtered from the plurality of nodes using the filter and each of the one or more nodes is configured to send a linking signal to the access point for establishing wireless communication with the access point.
